(19) United States
(12) Patent Application Publication
(10) Pub. No.: US 2017/0029198 A1
(43) Pub. Date: Feb. 2, 2017

(54) MODULAR STORAGE SYSTEM AND WORK STATION

(71) Applicant: INFINITY KEYBOARD, INC., MOORPARK, CA (US)

(72) Inventors: DUSTIN R. PRATT, NO. HOLLYWOOD, CA (US); MUSTAFA NOORZAI, MOORPARK, CA (US); OMAR NOORZAI, CAMARILLO, CA (US); GEORGE J. HUANG, RANCHO CUCAMONGA, CA (US)

(73) Assignee: INFINITY KEYBOARD, INC., MOORPARK, CA (US)

(21) Appl. No.: 14/858,728

(22) Filed: Sep. 18, 2015

Related U.S. Application Data
(60) Provisional application No. 62/198,248, filed on Jul. 29, 2015.

(51) Int. Cl. B65D 81/36; B65D 25/28; G06F 1/16; B65D 6/00

(52) U.S. Cl. CPC B65D 81/361; B65D 11/20; B65D 25/28; G06F 1/1633

(57) ABSTRACT

A modular storage system and work station comprised of connectable modules that are operative to form portable work spaces that are easily adjustable and provide for an attachment system that allows for various accessories, computers, notebooks and the like to be detachably secured to the work station. In a preferred embodiment, the modules are comprised of a honeycomb-like structure that is operative to allow for the attachable interconnection of male- and female-type parts. The modular storage system and work station of the present invention may further be designed to be operatively transitional from a first carrying case-type configuration to a work station configuration, the latter defining a selectively adjustable work surface to which various accessories can be attached and selectively positioned. The storage system can also be scaled up to support larger equipment or serve as a display system with the help of electrical lighting elements, or scaled down to serve as more personal storage units such as a tool box or lunch box.

### CROSS-REFERENCE TO RELATED APPLICATIONS

The present application claims priority to U.S. Provisional Patent No. 62/198,248, entitled MODULAR CONNECTABLE SYSTEM FOR FORMING FUNCTIONAL OR DECORATIVE STRUCTURES, filed Jul. 29, 2015, all of the teachings of which are incorporated herein by reference.

### STATEMENT RE: FEDERALLY SPONSORED RESEARCH/DEVELOPMENT

Not Applicable

### BACKGROUND

The telecommunications revolution created by the Internet has radically altered conventional work place and educational settings, and in particular how and where people work and learn. In this regard, portable electronic devices, such as laptops, notebooks, and the like with a network connection to the Internet can enable anyone to work from virtually anywhere. Instead of a conventional office building or classroom environment, individuals instead have the ability to perform those identical tasks in the environment of their choosing. As a consequence, virtually any place in the world with a network connection can serve as an office or classroom.

Despite such limitless options, substantial problems still exist insofar as that it is often crucial to have a work space infrastructure necessary to perform prolonged computing tasks, other work or learning activities traditionally performed about a desk-like environment. Along these lines, simply using an electronic device in the absence of other ancillary work space support items, such as a desktop-like work surface with access to writing instruments, paper, notepads, a lighting source and beverage support—and in particular, coffee—becomes substantially less efficient. Indeed, despite the portable nature of many consumer electronic devices, the use of such devices outside conventional office and classroom environments often becomes impractical and inefficient. In this regard, unless an appropriate work space area can be created that enables an individual to be comfortable and focused and without being cramped or having to strain in order to perform functions such as typing or viewing a computer monitor, for example, worker efficiency and the purported advantages of working remotely are substantially compromised.

Accordingly, there is a substantial need in the art for a portable work station that can be easily and readily assembled to not only create a comfortable and efficient work space, but can do so in a manner that is extremely compatible with any of a variety of portable electronic devices and is easily customizable to create a work space to fit the needs of a specific individual. There is likewise a need for such a work station that is exceptionally space efficient and operative to create an ideal work space in very small areas, which is particularly ideal for settings such as airports, dorm rooms and the like. There is further a need for such a work station that is extremely portable in nature, and can further operatively transition into a storage system that is not only easy to handle, but can further serve as a container, such as a carrying case, so as to facilitate the transportation of useful items, such as desktop items, writing instruments, paper, notepads, staplers and any of a variety of portable electronic devices, and enable such items to be easily transported and sufficiently protected. Along those lines, it would be advantageous for such work station to assume a storage system configuration that enables all such items to be easily and readily transportable.

There is still a further need in the art for such a work station system that is modular in nature, easy to assemble, can be made from exceptionally durable materials, and can be interconnected with any of a variety of accessories to enhance the function and operation thereof. Along those lines, it is particularly noted that there is a substantial need for such a modular storage system and work station that can be designed to be exceptionally ergonomic in nature and further facilitate an active work space area so as to prevent well-recognized health concerns associated with prolonged periods of passive activity, such as prolonged periods of sitting, typing and the like, to thus prevent a host of work-related health concerns, such as heart disease, muscle fatigue, and repetitious strain activities.

### BRIEF SUMMARY

The present invention specifically addresses and alleviates the above-identified deficiencies in the art. In this regard, the present invention is directed to a modular storage system and work station comprised of a system of connectable modules that allows for the creation of highly portable yet light-weight workspaces; easily adjustable and modifiable surfaces; and surfaces that allow for attachments of various apparatus for the purpose of securing, positioning, or adding functionalities thereto. According to a preferred embodiment, the invention incorporates a system of connectable modules utilizing the unique features and characteristics of hexagons in a honeycomb-like pattern whereby connectivity is achieved by smaller, “male” hexagon members that can be detachably inserted into a larger “female” hexagon that is either completely or partially empty in the interior. The connectable features of such a system allow for the creation of many items of functional or decoration purposes, including but not limited to functional and decorative structures and surfaces.

To that end, the present invention incorporates the use of panels, which resemble a panel of honeycombs, that can be used as functional surfaces to receive a wide range of attachments. The panels can advantageously allow for the pass-through of wires and pipes and allow for attachments such as lighting or holding apparatus for other items. The attachments can be made permanent or semi-permanent through minor modifications to the connecting parts. Moreover, when placed on a floor or similar surface, such panels can be used to receive temporary or permanent structures for the purpose of securing or positioning them. This could be useful in situations where certain items need to be temporarily immobilized (e.g., an item being worked upon) or secured (e.g., lighting for a photoshoot and stage props).

According to a preferred embodiment, the modular storage system and work station of the present invention is configured to be operatively transitional between a first contained configuration which may take the form of a first compact, carrying case-type configuration whereby work surfaces, modular panels and the like are packed to assume a carrying case shape and size, including a handle member for ease in handling. To form such carrying case configuration in an embodiment of the present invention there is provided first and second shell members formed as minor-images of one another that are connectable to one another by a hinge. The shell members are further provided with latch mechanisms for interconnecting with one another so as to assume a closed carrying-case configuration, similar to a conventional attaché-type case. Such configuration further defines an interior space that is operative to hold numerous other accessories and personal items, which can include any of a variety of portable electronic devices, such as a laptop, notebook and the like, as well as any of a variety of desktop accessories, such as pencil holders, portable desk lamps, coasters, beverages, and any of a variety of support devices for use with the portable electronic device so as to place the device in optimal position for use as part of the work station when so assembled.

In use, the container or carrying case configuration is opened up or expanded to define a work surface upon which the user may place various items as part of a work station. To that end, the honeycomb structure will provide a myriad of options for the user to selectively configure the work surface, which may be configured to have a smooth, flat area defined by flat panels engageable with the honeycomb structure to thus enable the user to write upon the surface or make other drafting tasks. Such honeycomb structure further enables a wide variety of accessories to be selectively positioned upon the work surface so as to optimally serve the needs of the user.

This system further includes interlocking modules, preferably formed as panels that can interconnect with those portions of the system defining the first container configuration as well as other like modules. To that end, the modules are likewise formed to have the honeycomb configuration along with selectively positioned “male” hexagon members. By virtue of their interconnectable nature, the work surface may be selectively set to have a desired height and/or angle relative the user. In this regard, the panels, by virtue of the male/female interconnectivity, can be interconnected to the undersurface of the underside of the work surface defined by the system when assuming its expended configuration, to thus enable the work surface to be raised or lowered as desired, and assume either a perpendicular configuration relative the ground or flat surface, or a selectively angled configuration, as may be desired for drafting tasks or as may be desired to create a podium-like structure. While in such expanded configuration, it is further contemplated that other modular components can be interconnected to the top surface of the work surface area, such as to selectively position a portable electronic device in a desired configuration so as to optimize the user's comfort and ability to use such portable electronic device.

In further refinements of the present invention, it is contemplated that the modular storage system and work station of the present invention may be utilized in conjunction with numerous other devices that are operative to not only provide a fully functional work station, but also an active-type work station that enables the user to engage in movement and activity so as to avoid prolonged sitting or inactivity while the work station is in use, particularly when used for conventional computing tasks requiring prolonged periods of time looking into a computer monitor and/or typing, and the like. Along those lines, it is contemplated that the modular storage system and work station of the present invention may be used in combination with other related inventions designed by applicants, including those disclosed and claimed in Applicants' pending U.S. patent application Ser. No. ______, entitled COMBINATION THERAPEUTIC AND EXERCISE SYSTEM and Ser. No. ______ filed ______ entitled SPLIT ROTATING KEYBOARD SYSTEM, the teachings of which are expressly incorporated herein by reference.

By integrating such active mechanisms as part of a work station environment, it is believed that the modular storage system and work station of the present invention not only provides an extremely space-efficient and fully functional work station system, but also can enable the work station to be utilized in a manner than minimizes many well-recognized health risks associated with prolonged passive periods of inactivity, particularly when engaged with the prolonged use of portable electronic devices.

### BRIEF DESCRIPTION OF THE DRAWINGS

These as well as other features of the present invention will become more apparent upon reference to the drawings, wherein:

FIG. 1 is a perspective view of a modular storage system and work station as constructed in accordance with a preferred embodiment of the present invention as assuming a first packaged, carrying case configuration.

FIG. 2 is a side view of the modular storage system and work station shown in FIG. 1.

FIG. 3 is the side view of FIG. 2 with flat side panels thereof removed and showing an internal honeycomb lattice structure.

FIG. 4 is a perspective view of the modular storage system and work station of FIGS. 1 and 2 as positioned on a side with flat side panels facing up.

FIG. 5 is an exploded view of the components of the modular storage system and work station as shown in FIGS. 1-4.

FIG. 6 is a perspective view of the modular storage system and work station shown assuming a second operative work space configuration and defining a work surface area operative to interconnect with various modular items shown in phantom.

FIG. 7 is a side view of a support module for use in supporting and interconnecting with the modular storage system and work station of the present invention.

FIG. 8 is a frontal view of the support module of FIG. 7 as shown interconnecting with a portion of the modular storage system and work station, the latter shown in phantom.

FIG. 9 is a side view of the modular storage system and work station of FIG. 7 wherein the support modules are shown assuming a first configuration as interconnected with the system so as to define a first profile work surface having height A.

FIG. 10 is a side view of the modular storage system and work station of FIG. 7 wherein the support modules are shown assuming a second configuration as interconnected with the system so as to define a second, lower profile work surface having height B.

FIG. 11 is a side-view of the modular storage system and work station wherein one of the support modules is shown assuming the low profile configuration of FIG. 10 and the respective other support module being shown in the higher profile configuration shown in FIG. 9.

FIG. 12 is a side-view of the modular storage system and work station wherein multiple support modules are interconnected to one another to define a higher work surface area having height C.

FIG. 13 is an elevated perspective view of modular components of the modular storage system and work station of the present invention that are operative to interconnect to the top surface of the work surface area so as to define a podium-like structure.

FIG. 14 is a perspective view of the components of FIG. 13 as shown in interconnected condition and operative to define a podium-like structure and operative to receive a portable electronic device, such as a laptop, tablet or other similar device.

### DETAILED DESCRIPTION

The detailed description set forth below is intended as a description of the presently preferred embodiment of the invention, and is not intended to represent the only form in which the present invention may be implemented or performed. The description sets forth the functions and sequences of steps for practicing the invention. It is to be understood, however, that the same or equivalent functions and sequences may be accomplished by different embodiments and that they are also intended to be encompassed within the scope of the invention.

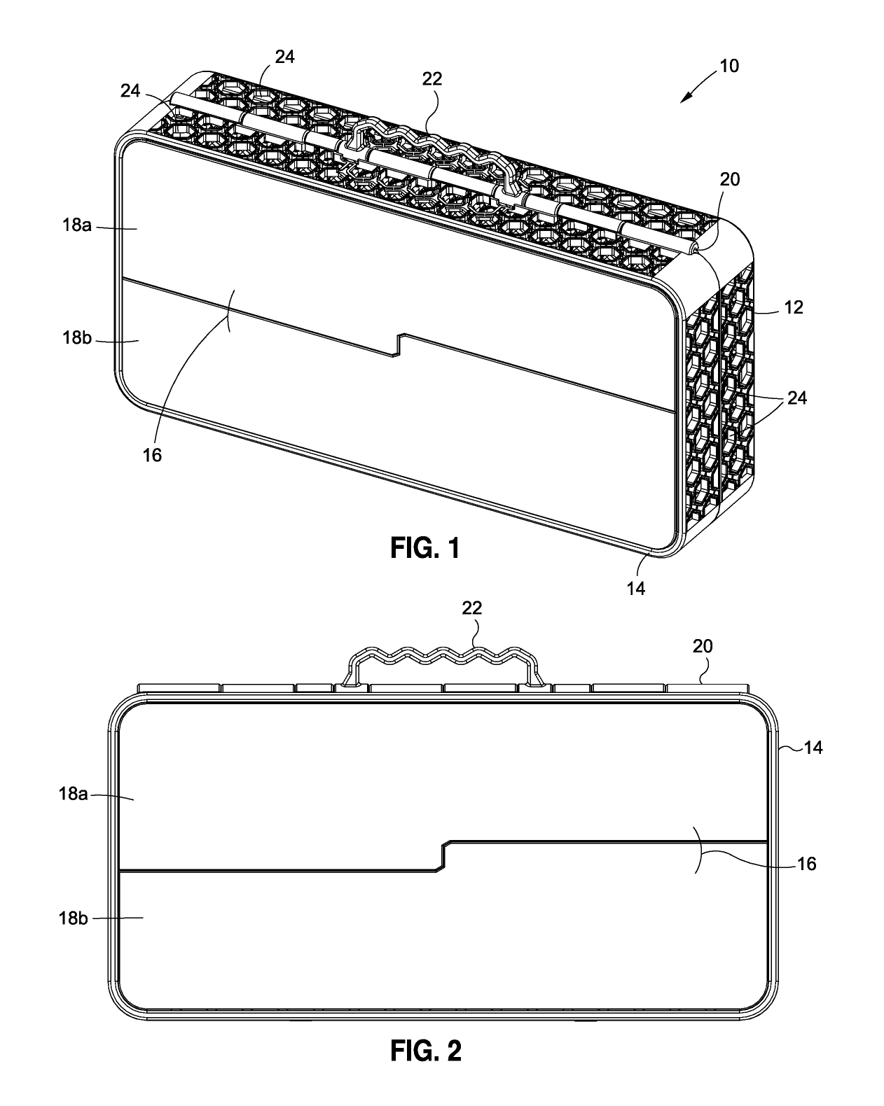

Referring now to the figures, and initially to FIG. 1, there is shown a modular storage system and work station 10 as constructed in accordance with a preferred embodiment of the present invention. As illustrated in FIG. 1, the system 10 is preferably configured to assume a first initial container configuration that may resemble a carrying case, such as a generally hard shell attaché case as shown. To create such structure, there are provided a first shell portion 12 and minor-image second shell portion 14 that are interconnected to one another via hinge 20. On the side of second shell portion 14 is a generally planar surface 16 defined by the combination of panel members 18a,18b. Due to the mirror-image design of shell portions 12,14, it should be understood that a similar surface area 16, as defined by like panel members 18a,18b may further be provided (not shown). The system 10 will thus define a side profile as depicted in FIG. 2 with the flat surface 16 as defined by panels 18a,18b facing outwardly. As discussed, the opposite side as defined by shell member 12 will also be identical in appearance due to its minor image design. To facilitate handling of the system 10 while in such carrying case configuration, there is provided a handle 22 disposed midsection along hinge 20 for handling by a user.

Formed about the exterior of the system 10 is a grid or series of equidistantly-spaced apertures 24 that are operative to facilitate interconnection with peg-type anchor members per a male-female type connection, as is well understood in the art. Such male-female interconnection, which serves as the basis for interconnecting various modules of the present invention, is discussed more fully below.

Referring now to FIG. 4, and as will be readily understood, by virtue of system 10 being positioned on a respective side, there is thus provided an upper planar work surface 16 as defined by panel members 18a,18b, which can thus serve as a work surface upon which various items, such as laptop computers, notebooks or any of a variety of personal electronic devices can be utilized. The upper surface 16 also defines a surface upon which a miniaturized, portable desk space can be utilized. Thus, even assuming the compact, carrying case configuration as shown in FIGS. 1 and 2, the system 10 of the present invention is thus operative to function as a portable work space by defining such planar work surface 16.

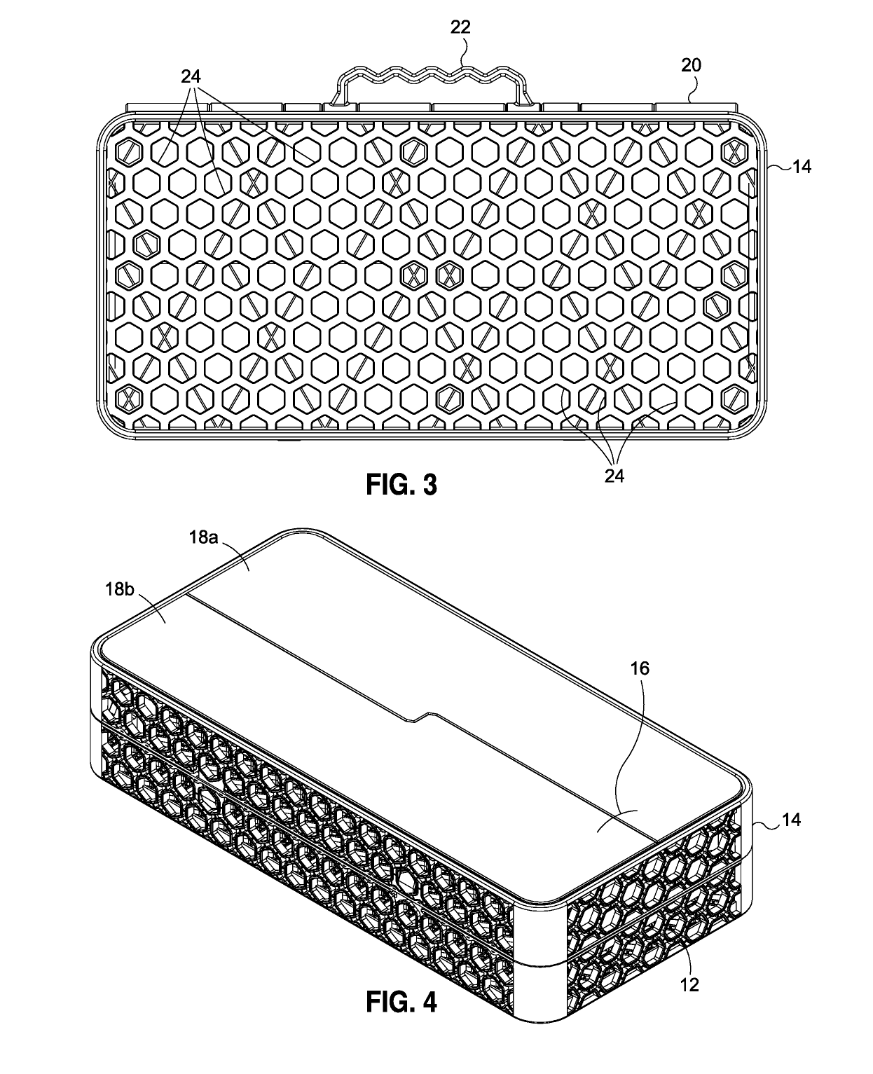

Referring now to FIG. 3, there is shown a respective side of second shell member 14 with panel 18a,18b removed therefrom and showing a plurality of apertures 24 as arranged in a grid-like system across such surface. In the embodiment shown, the apertures 24 are arranged as hexagonal apertures in a honeycomb-like pattern. As discussed more fully below, the connectable features of the system 10 of the present invention as provided by such honeycomb arrangement of apertures allows for the creation of many items of functional or decorative purposes, including but not limited to functional and decorative structures and surfaces that can be attached to the system 10.

Although a variety of apertures 24 may be provided in spaced arrangement per a number of designs and layouts as will be readily understood by those skilled in the art, it is believed that the hexagon/honeycomb structure as depicted in the figures provide several advantageous capabilities. Those capabilities include the fact that attachments can be put in at six different angles without additional mechanical means of angle adjustment insofar as the angles are in 60 degree increments. The hexagon is also a very strong shape in terms of resisting deformation from pressure exerted on its sides. A three-dimensional structure with hexagonal columns is also very strong in resisting pressure exerted on the hexagonal planes. This makes a column-based hexagonal system an attractive option for surfaces that has to endure pressure. The hexagon is also a very material-efficient design, which allows a honeycomb structure to achieve the highest specific strength (strength-to-weight ratio) among identical materials. While other types of aperture “grids” are believed to be suited for use with the present invention, any other such design using similar materials will likely be more costly and heavier than the hexagonal, honeycomb-inspired design. In this regard, the system 10 of the present invention may be fabricated from any of a wide variety of materials such as metal or molded plastic.

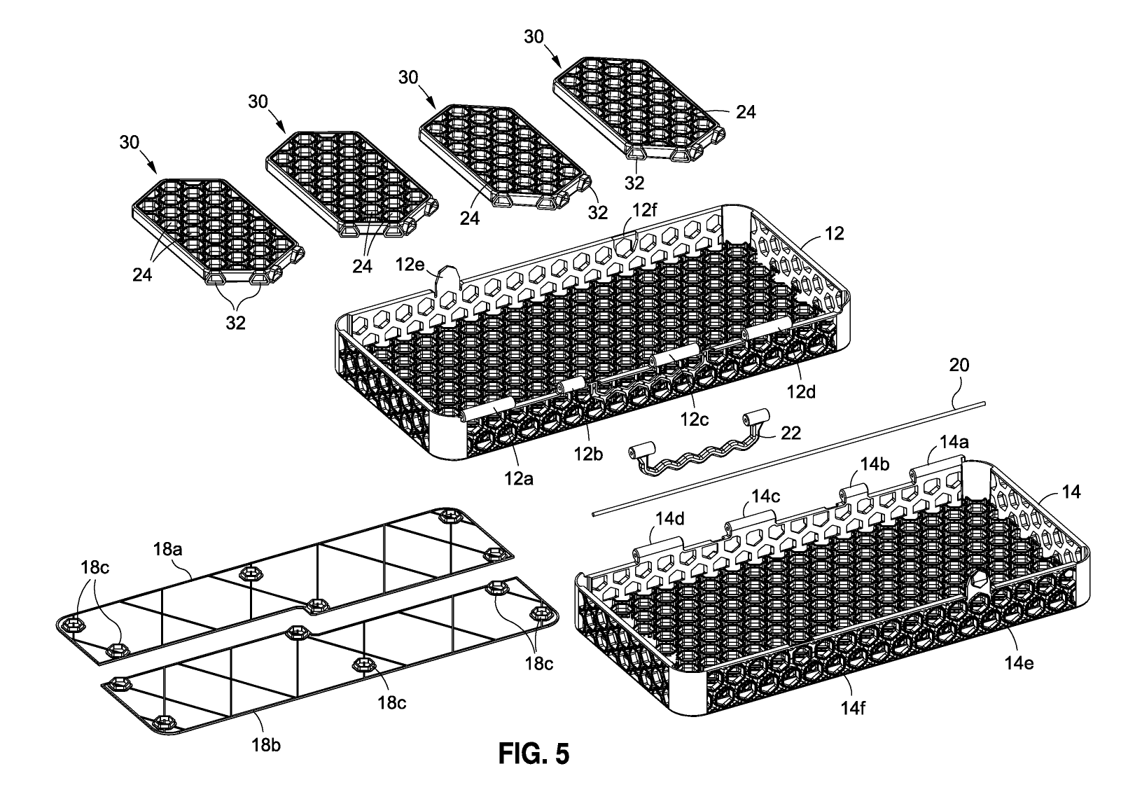

To maximize the versatility of the honeycomb arrangement of apertures, there is shown in FIG. 5 an exploded view of an exemplary system 10 as shown in disassembled form. As discussed above, when assuming the carrying case configuration of FIGS. 1-4, shell members 12,14 will cooperate to form an enclosed attaché case configuration. As shown in FIG. 5, the interconnection between shell members 12,14 will be operative to define an interior space within which various items may be stored when in the closed, carrying case configuration. Given the work station utility of the system 10 of the present invention, it is contemplated that the interior compartment defined by shell members 12,14 will be operative to store any of a variety of work items, including portable electronic devices, writing implements, paper, notepads, computer accessories, such as a touch pad or wireless mouse or any of a variety of typical desktop items, such as staplers, pencil holders, coasters for setting beverages, and the like when in the closed, carrying case configuration. The system 10 is further of very simple construction insofar as the shell members 12,14 are formed as mirror images of one another and may simply be held together through a hinge 20 extending through aperture portions 12a,12b,12c, and 12d of shell member 12 and apertures 14a, 14b, 14c, and 14d of second shell member 14 that are designed to align with one another. Handle 22 may also be integrated about hinge 20 as shown in FIGS. 1-3.

To further facilitate the interconnection between shell members 12,14 while in a closed state, shell members 12,14 will further be provided with interlocking members 12e,14e that are receivable into respective receiving apertures 12f,14f. As will be readily appreciated by those skilled in the art, such locking members and apertures 12e,14e,12f,14f will be readily understood and easily deployed by those skilled in the art and operative to maintain the shell members 12,14 in interconnected condition when assuming the carrying case/attaché case configuration. To the extent not already interconnected to the exterior of a respective shell member 12,14, panel members 18a,18b may further be stored within the interior of interconnected shell members 12,14 or may be attached to the exterior of either respective shell portion 12,14 to assume the configuration set forth in FIGS. 1, 2 and 4, by merely inserting hexagonal male anchor portion 18c within the appropriate hexagonal apertures formed on the exterior of shell members 12 or 14.

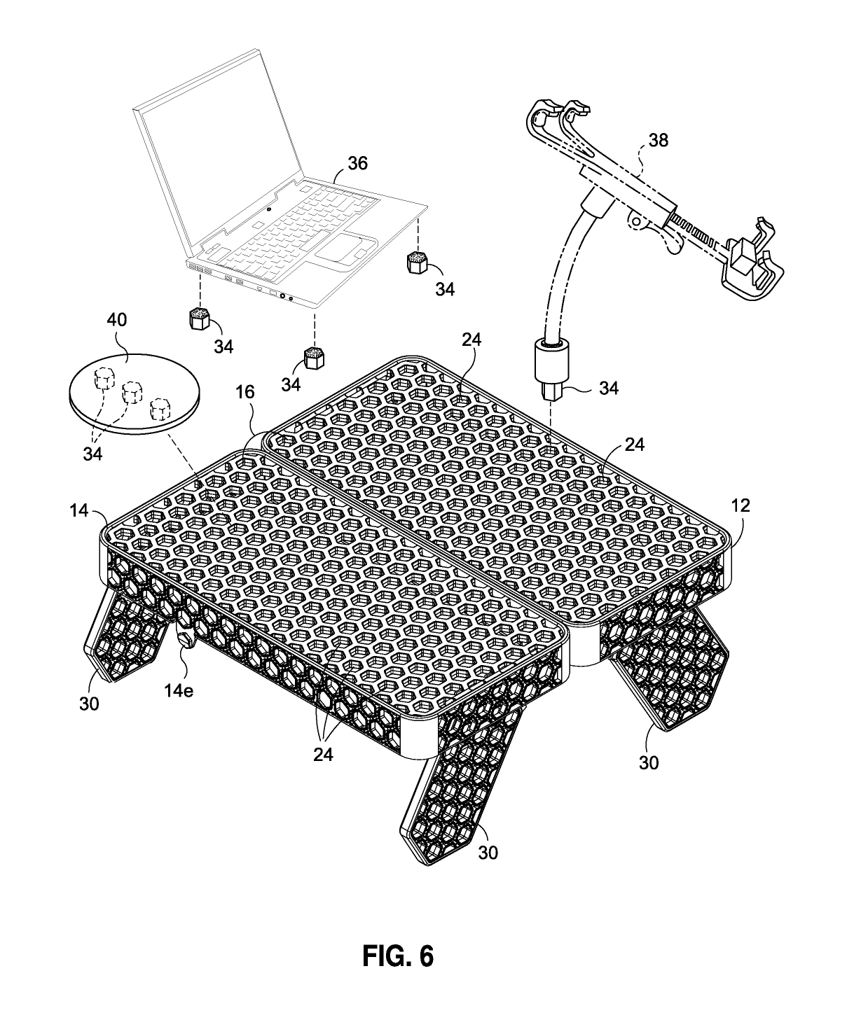

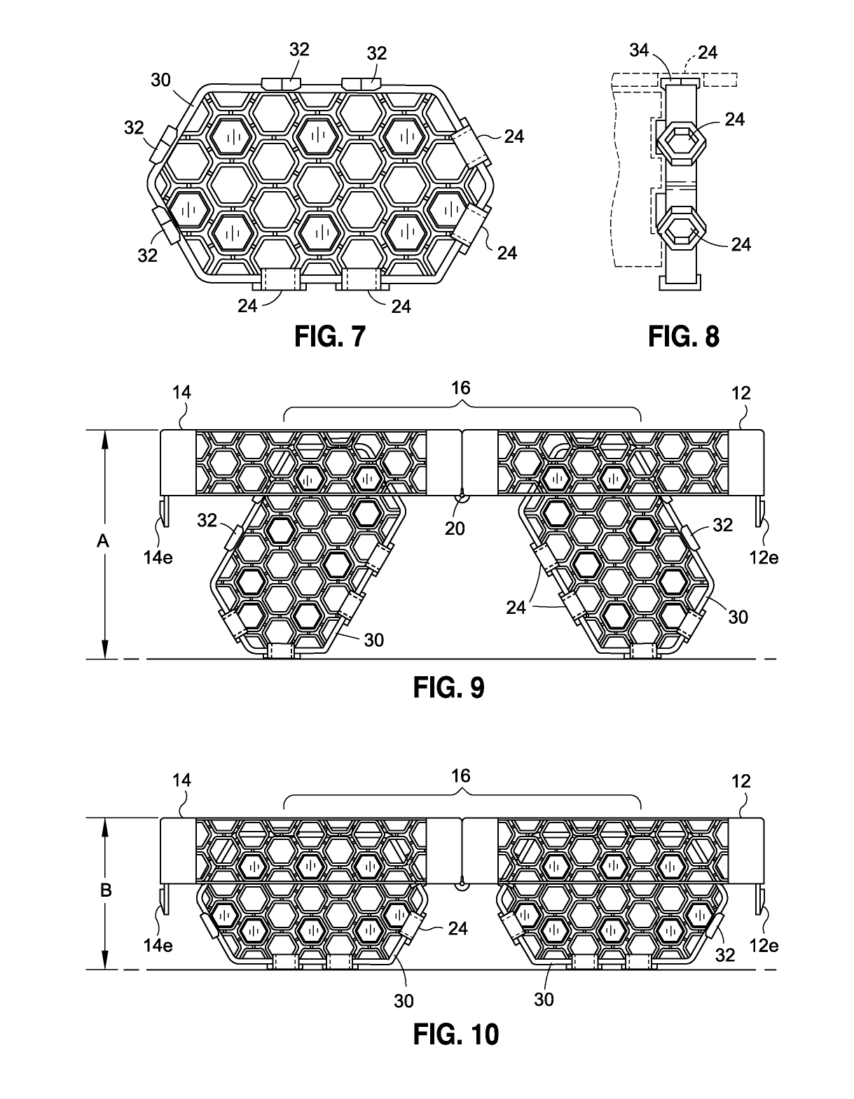

In order to provide for an extremely versatile and variable work station that can be readily created per the system 10 of the present invention, the system 10 further expressly incorporates the use of modular supports 30 that are operative to interconnect with shell members 12,14 as well as to other like supports 30, as shown in FIGS. 7 and 8. To that end, each of the modular supports 30 are provided with the honeycomb arrangement of hexagonal apertures 24 that are operative to receive hexagonal male anchor portions, such as 18c and 34, the latter being shown in phantom in FIG. 6. In order to maintain a lower profile, however, modular supports 30 may be provided with anchor portions 32, as shown in FIG. 5, which may be bisected hexagonal anchor members as shown that are still operative to nest and anchor within a hexagonal female aperture 24 and remain secured thereinto but with half the width of the hexagonal anchors, such as those shown in 18c of FIGS. 5 and 34 in FIG. 6.

With respect to how such modules 30 are operative to facilitate the transformation of the modular storage system and work station 10 of the present invention from its compact, carrying case configuration into a work station area, there is shown in FIG. 6 how one such configuration is readily achieved. As illustrated, shell members 12,14 are opened about hinge 20 (not shown) such that the side portions thereof cooperate to define work surface 16. Such work surface 16 is defined by the plurality of hexagonal apertures 24 arranged in the honeycomb fashion as shown, and thus define a grid upon which numerous work items can be secured via the use of interlocking hexagonal anchors 34.

As illustrated, the work surface 16 is operative to receive and interconnect with planar member 40 via hexagonal anchors 34 formed on the underside thereof and shown in phantom. Such panel member 40 may be operative to define a surface area to be used for a wireless mouse, support a coffee cup or any of a number of desk space functions. Similarly, a portable computer 36 may be secured to the work surface via hexagonal anchor members 34 that are selectively positioned about the underneath portion of computer 36 and operative to be received within respective ones of apertures 24 formed upon work surface 16.

As further illustrated, a mount 38, shown in phantom, which may be operative to hold a portable electronic device in any of a variety of configurations, may likewise be interconnected to the work surface 16 by connection of anchor 34 into respective one of apertures 24. As will be readily appreciated by those skilled in the art, the interconnection between anchor members 34 and any of the variety of apertures 24 may be selectively chosen, with the anchors readily detached and selectively repositioned as desired, so that any of a variety of accessories can be attached to the work surface 16 in any configuration as desired.

To facilitate the ability of the work surface 16 to attain a desired height, there is shown in FIGS. 7 and 8 how the modular supports 30 support such work surface 16, as shown in FIG. 6. Hexagonal anchor portions 32 may be received into portions of the apertures 24 formed on the interior side of shell portions 12,14 such that the module supports 30 are operative to raise the upper work surface 16 as shown. In this regard, the modular supports 30 are operative to selectively raise the work surface 16 by virtue of their interconnection to the interior underside of shell members 12,14.

Referring now to FIGS. 9-12, and initially to FIG. 9, there are shown examples of a myriad of ways by which the modular supports 30 may be selectively interconnected to shell members 12,14, as well as to one another, to thus define an upper work surface 16 that may be set at a desired height and/or angle. As illustrated in FIG. 7, the modular supports 30 is provided with not only an interior array of hexagonal apertures 24, but the periphery thereof is provided with two sets of outwardly facing hexagonal apertures 24, as well as anchors 32, as shown. By virtue of the placement of such apertures 24 and anchors 32 about the periphery of modular support 30, the modular support 30 is thus able to interconnect to not only the apertures 24 formed within the interior undersides of shells 12,14, but are likewise operative to interconnect with other like modules. As shown in FIG. 9, modular supports 30 are shown as interconnected to the interior underside of shells 12,14 as fully extended about hinge 20 to define level work surface 16. In such configuration, the work surface 16 is thus raised a height A from a given surface. In this regard, the modular supports 30 are shown being attached to the interior underside of shell portions 12,14 at an angled configuration to thus maximize height.

To the extent a lower profile height, such as B shown in FIG. 10 is desired, the modular supports 30 may be positioned in a side profile such that upwardly extending anchor portions 32 are received within the interior underside of apertures 24 formed on the shell members 12,14. When two such modular supports 30 are the same configuration, as shown in FIGS. 9 and 10, the work surface 16 defined by the cooperative upwardly facing surfaces of shell members 12,14 is in substantially parallel relation to the support surface.

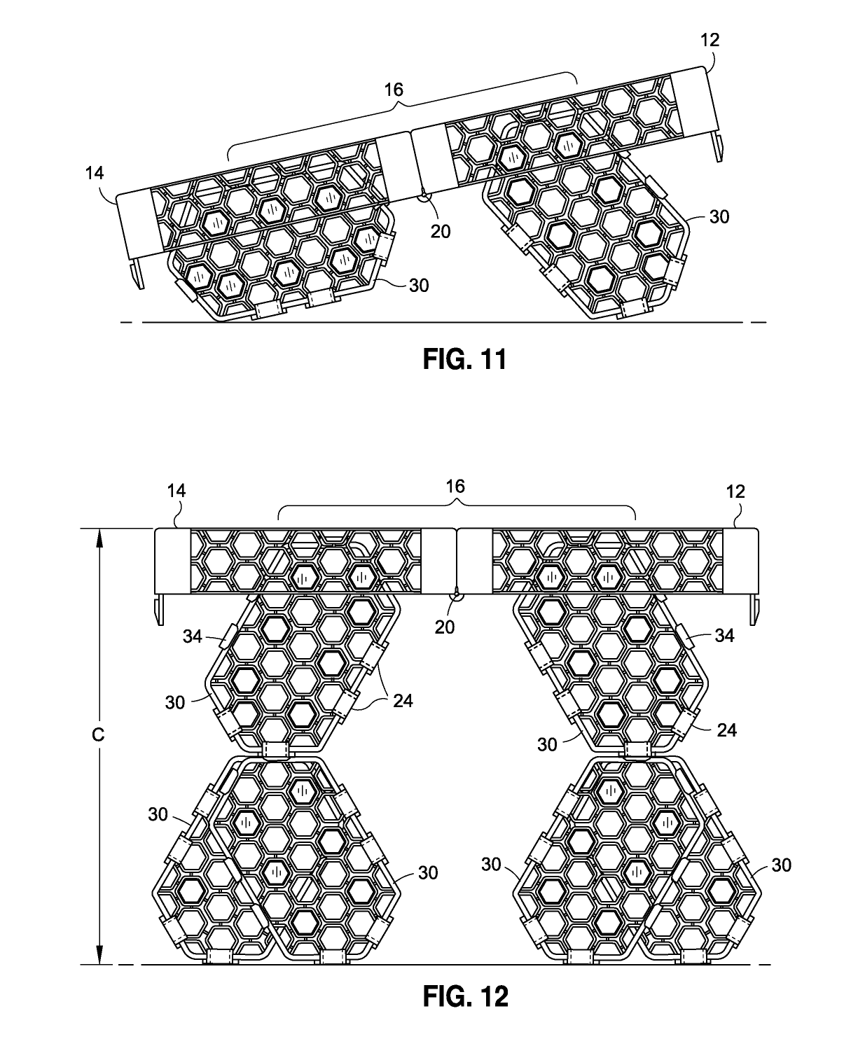

To the extent it is desired to have a work surface 16 that has an angled configuration, such as that shown in FIG. 11, the modular supports 30 may be interconnected to the interior underside of shell portions 12,14 such that one of the modular supports assumes a side-configuration, as shown on the left, while the respective other modular support 30 is shown interconnected in an angled configuration, as shown to the right. By virtue of the different side profiles of the modules, the work surface 16 will thus correspondingly have an incline, which may be desired for drafting purposes and the like.

To the extent a greater height is desired, such as C shown in FIG. 12, the interconnected modular supports 30 may be attached to the interior underside of shell members 12,14, and then further interconnected to other like modular supports 30 to thus form the two tier structure as shown. By virtue of the interconnection between all hexagonal male and female portions, the user is thus able to selectively modify the height and/or incline of the work surface 16 as may be desired, which can be adjusted from a very low profile, sitting position, to a fully standing podium-like configuration. By virtue of the honeycomb arrangement of the hexagonal apertures, and the male hexagonal anchors that can fit thereinto, the user is thus not only able to define a versatile work surface 16, but can do so while providing limitless ways to attach various items to the top of such work surface 16.

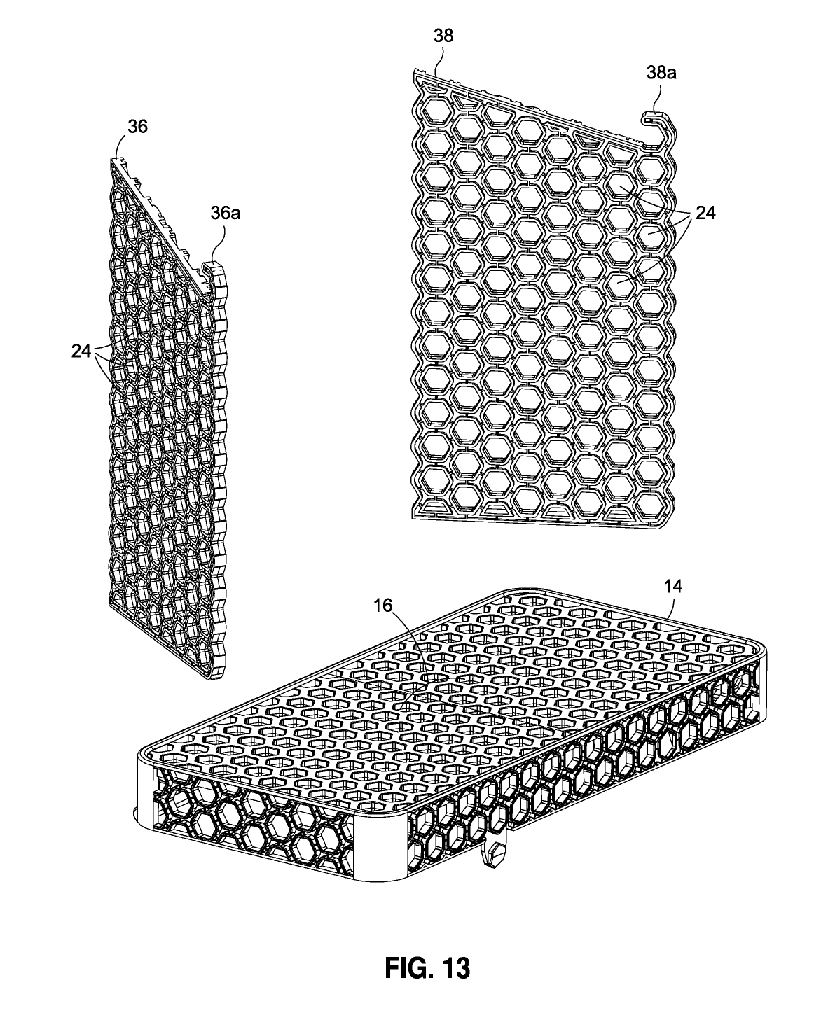

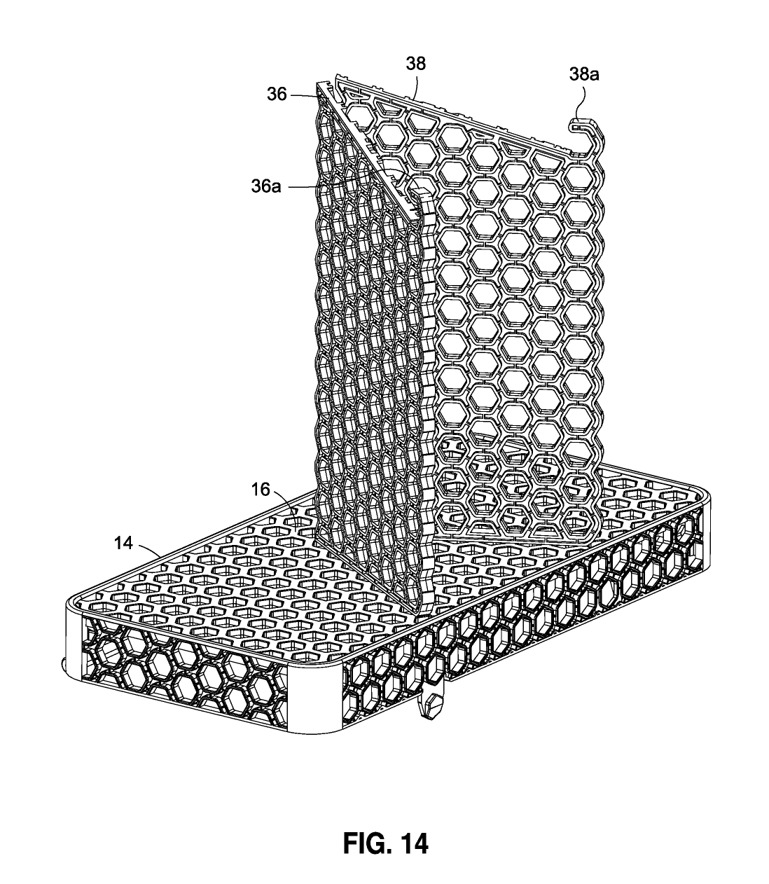

With respect to such myriad of options, there is shown in FIGS. 13 and 14, one such configuration whereby specialized podium modules 36,38 may be interconnected to the work surface 16, as well as each other, to define a podium that is operative to interconnect and support a computer laptop, for instance. The individual pieces 36,38 are shown disassembled from one another in FIG. 13, and in FIG. 14 are shown assembled to one another upon work surface 16 such that support portions 36a,38a slope downwardly and are provided with hook members so as to provide support to the personal computer or other item that may be supported thereby. Advantageously, such configuration enables a standing work station to be easily and readily created that may be selectively adjusted to provide optimal comfort to a particular individual using such work station system.

As will be readily appreciated by those skilled in the art, the system 10 of the present invention can be used to create strong yet light weight portable or non-portable structures. As mentioned above, the honeycomb inspired male/female design allows for strong yet easily removable attachments at both coplanar and perpendicular angles.

The system also envisions attachments that can achieve non-perpendicular angles through intentional non-planar design or mechanical means, such as a ball-in-socket joint. These designs allow attachments to achieve optimal and user-adjustable angles within their own physical limitations. Moreover, due to the plurality of apertures formed throughout the honeycomb network, wires can run through a variety of hexagonal apertures 24 to attach circuits or splice signals or to power sources and the like.

The system 10 is further operative to receive and interconnect with decorative surfaces whereby decorative elements can be attached to the male or female attachments provided throughout the system 10. Such decorative elements can have different colors and graphics, sayings, slogans, various brands, sports team logos, and the like. Along these lines, a wide range of arrangements can be made to further enhance such decorative features and can include, for example, decorative LED units. Other variations can include types of light displays or infrared sensors may be used such that once a sensor detects an infrared signal, it can cause an LED to flash or indicate the reception of such signal.

It is further expressly contemplated that the modular storage system and work station 10 of the present invention may be incorporated as part of an active work station system whereby not only is the modular storage system portable and operatively transitional to a functional work station, such work station will be active in nature and can be incorporated as part of a physically active system that enables a user to work on a portable electronic device, such as a laptop or notepad, but to do so while in a standing configuration, or in a manner that enables the individual to move and not remain stationary and simply perform repetitious typing activity while staring at a monitor while in a sitting position. To that end, it is believed that the modular storage system and work station 10 of the present invention may be readily utilized with and incorporate inventions conceived by Applicant that relates to an active work station environment. Such inventions are set forth in pending U.S. patent application Ser. No. ______, entitled COMBINATION THERAPEUTIC AND EXERCISE SYSTEM and Ser. No. ______ filed ______ entitled SPLIT ROTATING KEYBOARD SYSTEM, the teachings of which are expressly incorporated herein by reference.

Additional add-on components not mentioned in this description can be developed to provide functions commonly requested by users, including but not limited to USB plugs for charging electronic devices, tablet or phone holders, clips to attach multiple components and units to form larger working surfaces or other structures such as a column, box, or a small wall for purposes such as trade show displays, etc.

The hexagonal panels can be extended in length, width, and height by locking with compatible panels that have interlocking features built-in, or through special clips that securely attach two or more panels to form a larger surface.

The hexagonal panels can also form three dimensional structures with the use of locking elements designed to connect two panels perpendicularly or at any angle of choice.

Through the choice of materials or supplemental ingredients or components, the present invention will be able to provide additional beneficial capabilities as well, including but not limited to the increase in fiction, ability to help clean the air, ability to resist dust accumulation, provide limited lighting through fluorescence, etc.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

What is claimed is:

1. A modular storage system and work station comprising:
at least one container member having a plurality of apertures formed thereon wherein each respective one of said apertures is operative to receive and interconnect with an anchor member positionable therein, said anchor member being operative to attach an accessory to said container member; and
a generally flat surface formed upon a portion of said container member having said apertures formed thereon, said surface being operative to define a work surface upon which said anchor members may be received and to which said accessories can be attached.

2. The system of claim 1 wherein said container member is defined by first and second shell members that are operatively transitional between a first interconnected configuration whereby said first and second shell members define an interior compartment defining a storage area, and transitional to a second operative, expanded configuration whereby said first and second shell members cooperate to define said work surface, said first and second shell members having dedicated flat surfaces formed thereon that cooperates to define said work surface.

3. The system of claim 2 wherein said first and second shell members are operative to detachably engage one another to maintain said first closed configuration.

4. The system of claim 2 wherein said system further comprises a handle mechanism to facilitate the transportation of said first and second shell members when said shell members are interconnected to one another.

5. The system of claim 4 wherein said first and second shell members having said handle formed thereon are operative to define a carrying case when said first and second shell members are maintained in an interconnected condition.

6. The system of claim 1 wherein said apertures comprise hexagonal apertures formed in a honeycomb-type arrangement about each respective shell member, said plurality of hexagonal apertures each being operative to receive hexagonal anchor members positionable therein for attaching said accessories to said shell members.

7. The system of claim 2 wherein such system further comprises at least two modular supports operative to interconnect with said first and second shell members when said shell members assume said second operative, expanded configuration defining said work surface, said modular supports being selectively interconnectable to said shell members such that the height of said work surface defined by said first and second shell members may be selectively adjusted.

8. The system of claim 2 wherein such system further comprises at least two modular supports operative to interconnect with said first and second shell members when said shell members assume said second operative configuration defining said work surface, said modular supports being interconnectable such that the incline of said work surface defined by said first and second shell members may be selectively adjusted.

9. The system of claim 2 wherein such system includes at least four modules or supports, said modules or supports being interconnectable to said first and second shell members and also being interconnectable to like modular supports, said modular supports being interconnectable to said shell members and to other like modules such that said height and incline of said work surface defined by said first and second shell members may be selectively adjusted.

10. The system of claim 2 wherein said system is formed from molded plastic.

11. The system of claim 2 further comprising at least one accessory selected from the group consisting of: flat panels operative to define planar surfaces when said panels are interconnected via at least one anchor to said planar surface of apertures formed upon said work surfaces; holding devices operative to secure user's items such as cups, cables, and writing instruments; and mounting devices operative to hold and selectively position a portable electronic device, said portable electronic device being selected from the group consisting of a portable computer, tablet, writing instruments, or any equipment desired by the user.

12. The system of claim 2 wherein said system is operative to interconnect with at least one lighting source.

13. The system of claim 12 wherein said lighting source is an LED light.

14. The system of claim 2 further comprising a decorative item of artwork detachably interconnectable to said container member. The system of claim 9 wherein any of the modular supports can be expanded in length, width, and height through built-in interlocking.

15. The system of claim 9 wherein any of the modular supports can be attached to other modular supports at any angle through built-in interlocking designs.

16. The system of claim 2 wherein said work surface is operative to receive at least one member operative to define a podium upon which a portable electronic device may be positioned.
